(19) United States
(12) Patent Application Publication
(10) Pub. No.: US 2009/0018964 A1
(43) Pub. Date: Jan. 15, 2009

(54) METHODS, SYSTEMS, AND COMPUTER PROGRAM PRODUCTS FOR PERFORMING A TRANSACTION IN WHICH A CERTIFIER PROVIDES IDENTIFICATION INFORMATION FOR AUTHENTICATING A CUSTOMER AT THE POINT OF SALE

(75) Inventors: Charles Liu, Chapel Hill, NC (US); Daniel P. Homiller, Cary, NC (US); Nadi Findikli, Cary, NC (US); William O. Camp, JR., Chapel Hill, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/777,576

(22) Filed: Jul. 13, 2007

(51) Int. Cl. G06Q 20/00; G06F 17/30; G06Q 30/00; H04L 9/32

(52) U.S. Cl. 705/76; 705/44

(57) ABSTRACT

An electronic device performs a transaction by providing purchaser information for communication to a certification facility, receiving identification information associated with the purchaser from the certification facility, and completing the transaction responsive to authentication of the user of the electronic device as being the purchaser based on the received identification information.

### BACKGROUND OF THE INVENTION

The present invention relates to secure transactions, and, more particularly, to methods, systems, and computer program products for performing transactions using Near Field Communication (NFC) technology.

NFC is a short-range, wireless connectivity technology standard that is designed to enable simple and secure communication between electronic devices. NFC technology operates by using magnetic field induction and allows connectivity to be achieved between two devices by simply bringing the two devices within a few centimeters of one another. NFC technology may be used in a variety of applications, such as contactless transactions (e.g., payment and ticketing), calendar synchronization, electronic business cards, and/or acquiring information from the surrounding environment, e.g., reading tags from posters, billboards, packaging, and the like. For applications such as monetary transactions involving credit cards, virtual payment cards, e-money, ticketing, and/or the like, security may be a concern. For example, if a mobile terminal, such as a cellular phone, is equipped with NFC technology and includes credit card information and/or e-money thereon, then if the phone is lost or stolen, another party may be able to make purchases using the phone by merely placing the phone in proximity to an NFC-enabled point-of-sale terminal.

### SUMMARY OF THE INVENTION

According to some embodiments of the present invention, an electronic device performs a transaction by providing purchaser information for communication to a certification facility, receiving identification information associated with the purchaser from the certification facility, and completing the transaction responsive to authentication of the user of the electronic device as being the purchaser based on the received identification information.

In other embodiments, the identification information includes an image.

In still other embodiments, the image contains a verification indicium.

In still other embodiments, the verification indicium is a digital watermark.

In still other embodiments, completing the transaction includes presenting the image to a seller and receiving a transaction authorization from the seller responsive to a determination by the seller that the image is associated with the user of the electronic device.

In still other embodiments, the identification information includes a challenge.

In still other embodiments, completing the transaction includes receiving a response to the challenge from the user of the electronic device and authenticating the user of the electronic device as being the purchaser when the response received is correct.

In still other embodiments, the identification information is encrypted with a key known to a seller and unknown to the user of the electronic device.

In still other embodiments, completing the transaction includes receiving the key from the seller and decrypting the identification information using the key from the seller.

In still other embodiments, the method further includes defining a personal identification code associated with the purchaser and receiving a code that is input by the user of the electronic device. Providing the purchaser information includes providing the purchaser information for transmission to the certification facility when the code that is input by the user of the electronic device matches the defined personal identification code associated with the purchaser.

In still other embodiments, the purchaser information is encrypted.

In still other embodiments, providing purchaser information for communication to a certification facility includes transmitting the purchaser information to a point-of-sale terminal for forwarding to the certification facility.

In still other embodiments, transmitting the purchaser information to the point-of-sale terminal includes transmitting the purchaser information to the point-of-sale terminal using near field communication (NFC) technology.

In still other embodiments, providing purchaser information for communication to a certification facility includes transmitting the purchaser information to the certification facility.

In still other embodiments, completing the transaction includes completing the transaction with a point-of-sale terminal using near field communication (NFC) technology.

In still other embodiments, the electronic device is a mobile terminal.

In still other embodiments, an electronic device is configured to carry out one or more of the above-described methods.

In further embodiments of the present invention, a point-of-sale terminal performs a transaction by receiving identification information associated with a purchaser from a certification facility, authenticating a customer as being the purchaser based on the received identification information, and completing the transaction responsive to authentication of the customer as being the purchaser.

In still further embodiments, the identification information includes an image.

In still further embodiments, the image contains a verification indicium.

In still further embodiments, the verification indicium is a digital watermark.

In still further embodiments, the identification information includes a challenge.

In still further embodiments, completing the transaction includes presenting the challenge to the customer and receiving a response to the challenge from the customer. Authenticating the customer includes authenticating the customer as being the purchaser when the response received is correct.

In still further embodiments, completing the transaction includes presenting the image to a seller and receiving a transaction authorization from the seller responsive to a determination by the seller that the image is associated with the customer.

In still further embodiments, the method further includes receiving purchaser information from an electronic device associated with the customer and forwarding the purchaser information to the certification facility. Receiving the identification information includes receiving the identification information associated with the purchaser from the certification facility responsive to forwarding the purchaser information to the certification facility.

In still further embodiments, receiving the purchaser information from the electronic device includes receiving the purchaser information from the electronic device using near field communication (NFC) technology.

In still further embodiments, completing the transaction includes completing the transaction with an electronic device associated with the customer using near field communication (NFC) technology.

In still further embodiments, a point-of-sale terminal is configured to carry out one or more of the above-described methods.

In other embodiments of the present invention, a certification facility facilitates a transaction by receiving purchaser information and sending identification information associated with the purchaser to an electronic device associated with a customer and/or a point-of-sale terminal associated with a seller.

In still other embodiments, the identification information includes an image.

In still other embodiments, the image contains a verification indicium.

In still other embodiments, the verification indicium is a digital watermark.

In still other embodiments, the identification information includes a challenge.

In still other embodiments, the identification information is encrypted with a key known to the seller and unknown to the customer.

In still other embodiments, the purchaser information is encrypted.

In still other embodiments, a certification facility system is configured to carry out one or more of the above-described methods.

In still other embodiments, a computer program product includes computer-readable program code embodied on a computer-readable medium, the computer readable program code being configured to carry out one or more of the above-described methods.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a network for performing a transaction in which a certification facility provides identification information to an electronic device and/or point-of-sale terminal to authenticate a customer in accordance with some embodiments of the present invention;

FIG. 2 is a block diagram that illustrates an electronic device/mobile terminal in accordance with some embodiments of the present invention;

FIG. 3 is a block diagram that illustrates a software architecture of a point-of-sale terminal in accordance with some embodiments of the present invention;

FIG. 4 is a block diagram that illustrates a software architecture of a certification facility system in accordance with some embodiments of the present invention; and

FIG. 5 is a flowchart that illustrates operations for performing a transaction in which a certification facility provides identification information to an electronic device and/or point-of-sale terminal to authenticate a customer in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device that is configured to communicate with a point-of-sale terminal to perform a transaction.

To improve security in performing financial transactions, many credit cards now include a picture of the owner the card to prevent or at least inhibit the ability of another person to use the card. Unfortunately, stolen credit cards can be cloned on to a new piece of plastic with a different picture. The use of watermarking over the picture can help, but sophisticated parties can sometimes reproduce the watermark with sufficient accuracy to fool a seller. Near Field Communication (NFC) technology can be used to facilitate financial transactions using, for example, a virtual credit card, e-money, and the like. Similar to a conventional credit card without a picture, however, if a device equipped with NFC and purchasing software were to be stolen, a party may be able to make unauthorized purchases while in possession of the device. The purchasing software may require entry of a personal identification code, such as a Personal Identification Number (PIN) before allowing a purchase to be made, but such security may be deemed insufficient.

Some embodiments of the present invention may provide enhanced security for electronic transactions between devices by communicating purchaser information to a certification facility. The certification facility responds with identification information for the purchaser, such as an image or challenge, which is communicated to a customer's device and/or a point-of-sale terminal. If the identification information is sent to the customer's device, then it may be encrypted with a key known to the seller to keep the customer from altering the identification information in some way or inserting different identification information. The customer can then be authenticated as the purchaser based on the identification information and the transaction can be completed.

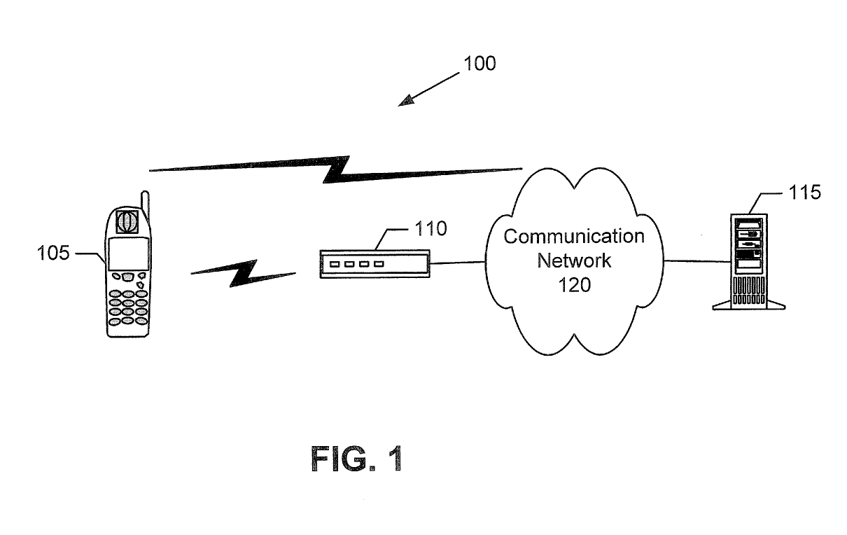

Referring now to FIG. 1, a network 100 for performing a transaction in which a certification facility provides identification information to an electronic device and/or point-of-sale terminal to authenticate a customer, in accordance with some embodiments of the present invention, includes an electronic device 105, such as a mobile terminal, a point-of-sale terminal 110, a certification facility system 115, and a communication network 120 that are connected as shown. The electronic device 105 may communicate with the point-of-sale terminal 110 using NFC technology to perform a transaction. It will be understood that embodiments of the present invention are not limited to the use of NFC technology for communication between the electronic device 105 and the point-of-sale terminal 110. Other types of wireless communication technologies including, but not limited to, WiFi, Bluetooth, and/or cellular may be used. The electronic device 105 and point-of-sale terminal 110 may also communicate using a wireline connection in some embodiments of the present invention. The point-of-sale terminal 110 may communicate with the certification facility system 115 via a communication network 120. The electronic device 105 may also communicate with the certification facility system 115 via the communication network 120. The communication network 120 may represent a global network, such as the Internet, or other publicly accessible network including one or more wireless and/or wireline communication nodes. The network 140 may also, however, represent a wide area network, a local area network, an Intranet, or other private network, which may not accessible by the general public. Furthermore, the communication network 120 may represent a combination of public and private networks or a virtual private network (VPN).

The electronic device 105 is described as a mobile terminal for purposes of illustrating some embodiments of the present invention. It will be understood, however, that the present invention is not limited to such embodiments and that the electronic device may be embodied as any electronic device that is configured to perform a transaction with the point-of-sale terminal 110. Thus, according to various embodiments of the present invention, the electronic device 105 may be a mobile terminal, such as a wireless phone, or may be relatively stationary device.

Although FIG. 1 illustrates an exemplary communication network 100, it will be understood that the present invention is not limited to such configurations, but is intended to encompass any configuration capable of carrying out the operations described herein.

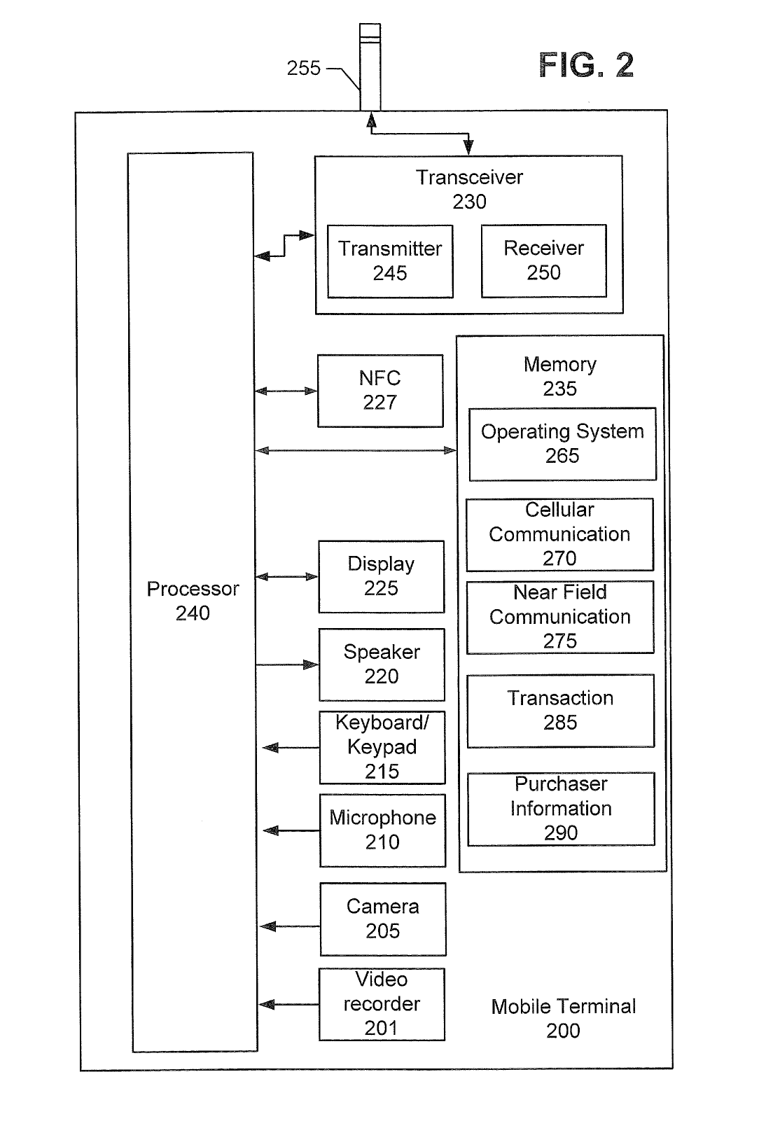

Referring now to FIG. 2, an exemplary mobile terminal 200 that may be used to implement a device, such as the electronic device 105 of FIG. 1, in accordance with some embodiments of the present invention, includes a video recorder 201, a camera 205, a microphone 210, a keyboard/keypad 215, a speaker 220, a display 225, a transceiver 230, and a memory 235 that communicate with a processor 240. The transceiver 230 comprises a transmitter circuit 245 and a receiver circuit 250, which respectively transmit outgoing radio frequency signals to base station transceivers and receive incoming radio frequency signals from the base station transceivers via an antenna 255. The radio frequency signals transmitted between the mobile terminal 200 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The mobile terminal also includes an NFC module 227 for providing short-range communication functionality with other NFC equipped devices and systems. The NFC module 227 may communicate with other NFC equipped devices using magnetic field induction over the 13.56 MHz frequency band. NFC may have a maximum communication range of about 10 centimeters.

The foregoing components of the mobile terminal 200 may be included in many conventional mobile terminals and their functionality is generally known to those skilled in the art.

The processor 240 communicates with the memory 235 via an address/data bus. The processor 240 may be, for example, a commercially available or custom microprocessor. The memory 235 is representative of the one or more memory devices containing the software and data used to operate the mobile terminal as well as to perform a transaction in which the user of the mobile terminal is authenticated as the purchaser. The memory 235 may include, but is not limited to, the following types of devices: cache, ROM, PROM, EPROM, EEPROM, flash, SRAM, and DRAM.

As shown in FIG. 2, the memory 235 may contain five or more categories of software and/or data: the operating system 265, a cellular communication module 270, NFC module 275, a transaction module 285, and/or a purchaser information module 290. The operating system 265 generally controls the operation of the mobile terminal 200. In particular, the operating system 265 may manage the mobile terminal's software and/or hardware resources and may coordinate execution of programs by the processor 240. The cellular communication module 270 may be configured to manage the cellular communication protocols that are used to allow the mobile terminal 200 to communicate with other devices and systems. The NFC module 270 may be configured to manage the NFC protocols that are used to allow the mobile terminal 200 to communicate with other NFC equipped devices and systems. The transaction module 285 may be configured to manage transactions with other devices using, for example, a virtual credit card, e-money, ticketing, and the like. The purchaser information 290 may comprise information defining one or more purchasers that may use the mobile terminal 200 for making transactions. For example, a mobile terminal 200 may be shared among family members with each member being allowed to make purchases. Each family member may be defined as part of the purchaser information 290 and a credit card, e-money, or the like may be associated therewith. As will be described in detail below, when a user of the mobile terminal attempts to make a transaction, the user selects his/her purchaser information to be communicated to a certification facility. Based on the received purchaser information, the certification facility responds by sending identification information associated with the purchaser to the mobile terminal 200 and/or the point-of-sale terminal. The identification information, such as an image, can then be compared with the user of the mobile terminal 200 to see if there is a match. If so, then the user of the mobile terminal is authenticated and the transaction is allowed to complete.

Although FIG. 2 illustrates an exemplary software and hardware architecture that may be used to perform a secure transaction, in accordance with some embodiments of the present invention, it will be understood that the present invention is not limited to such a configuration, but is intended to encompass any configuration capable of carrying out the operations described herein.

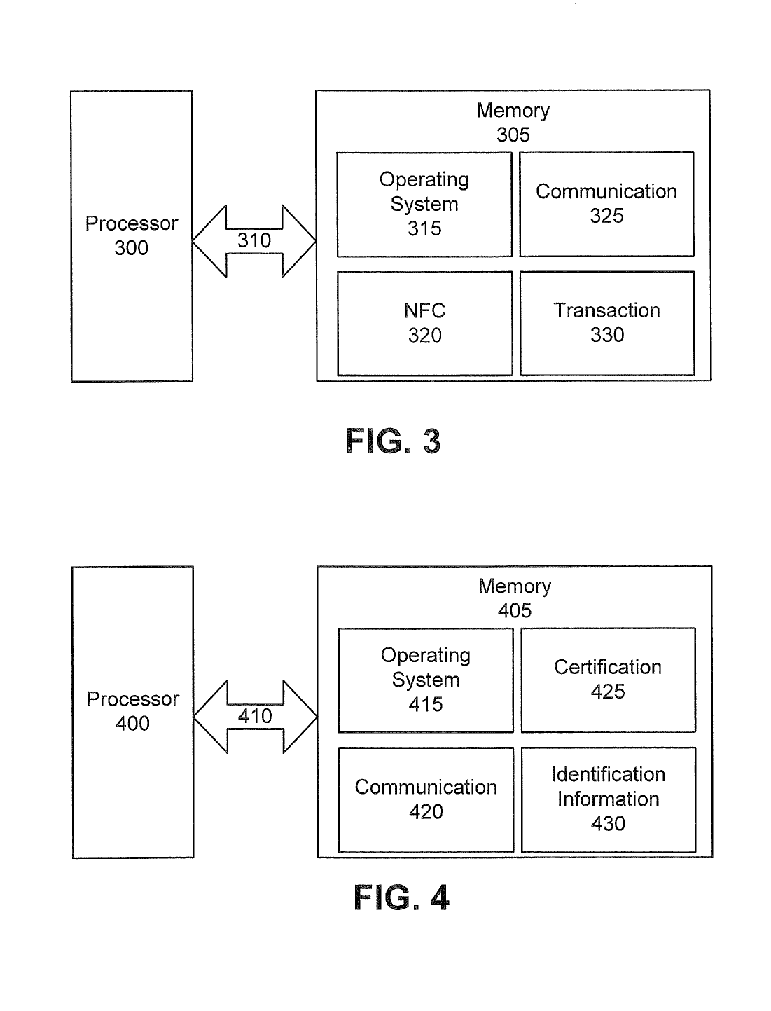

FIG. 3 illustrates a processor 300 and a memory 305 that may be used in embodiments of the point-of-sale terminal of FIG. 1 in accordance with some embodiments of the present invention. The processor 300 communicates with the memory 305 via an address/data bus 310. The processor 300 may be, for example, a commercially available or custom microprocessor. The memory 305 is representative of the one or more memory devices containing the software and data used to facilitate a point-of-sale transaction in accordance with embodiments of the present invention. The memory 305 may include, but is not limited to, the following types of devices: cache, ROM, PROM, EPROM, EEPROM, flash, SRAM, and DRAM.

As shown in FIG. 3, the memory 305 may contain up to four or more categories of software and/or data: an operating system 315, a NFC module 320, a communication module 325, and a transaction module 325. The operating system 315 generally controls the operation of the point-of-sale terminal. In particular, the operating system 315 may manage the point-of-sale terminal's software and/or hardware resources and may coordinate execution of programs by the processor 300. The NFC module 320 may be configured to manage the NFC protocols that are used to allow the point-of-sale terminal to communicate with other NFC equipped devices and systems. The communication module 325 may be configured to manage the communication protocols, including both wireless and wireline protocols, that are used to communicate with other devices and systems, such as the certification facility system 115, over the communication network 120 of FIG. 1. The transaction module 330 may be configured to manage transactions with other devices, such as the electronic device 105 of FIG. 1, using, for example, a virtual credit card, e-money, ticketing, and the like.

Although FIG. 3 illustrates an exemplary point-of-sale terminal software architecture in accordance with some embodiments of the present invention, it will be understood that the present invention is not limited to such a configuration but is intended to encompass any configuration capable of carrying out operations described herein.

FIG. 4 illustrates a processor 400 and a memory 405 that may be used in embodiments of the certification facility system 115 of FIG. 1 in accordance with some embodiments of the present invention. The processor 400 communicates with the memory 405 via an address/data bus 410. The processor 400 may be, for example, a commercially available or custom microprocessor. The memory 405 is representative of the one or more memory devices containing the software and data used to provide identification information for a purchaser in accordance with embodiments of the present invention. The memory 405 may include, but is not limited to, the following types of devices: cache, ROM, PROM, EPROM, EEPROM, flash, SRAM, and DRAM.

As shown in FIG. 4, the memory 405 may contain up to four or more categories of software and/or data: an operating system 415, a communication module 420, a certification module 425, and an identification information module 430. The operating system 415 generally controls the operation of the certification facility system. In particular, the operating system 415 may manage the certification facility system's software and/or hardware resources and may coordinate execution of programs by the processor 400. The communication module 420 may be configured to manage the communication protocols, including both wireless and wireline protocols, that are used to communicate with other devices and systems, such as the electronic device 105 and point-of-sale terminal 110, over the communication network 120 of FIG. 1. The certification module 425 is configured to receive purchaser information that is communicated from the electronic device 105 or forwarded from the point-of-sale terminal 110 and to respond by sending identification information 430 associated with the purchaser to the electronic device 105 and/or the point-of-sale terminal 110. In accordance with various embodiments of the present invention, the identification information 430 may be an image, which may include a digital watermark, a challenge, or other type of information that can be used to authenticate a customer/user of the electronic device 105 as being the purchaser. For additional security, the certification module 425 may encrypt the identification information 430 before sending it to the point-of-sale terminal 110 and/or the electronic device 105.

Although FIG. 4 illustrates an exemplary certification facility system software architecture in accordance with some embodiments of the present invention, it will be understood that the present invention is not limited to such a configuration but is intended to encompass any configuration capable of carrying out operations described herein.

Computer program code for carrying out operations of devices, terminals, and/or systems discussed above with respect to FIGS. 1-4 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to message flow, flowchart and/or block diagram illustrations of methods, devices, and/or computer program products in accordance with some embodiments of the invention. These message flow, flowchart and/or block diagrams further illustrate exemplary operations for performing a transaction in which a certification facility provides identification information to an electronic device and/or point-of-sale terminal to authenticate a customer in accordance with various embodiments of the present invention. It will be understood that each message/block of the message flow, flowchart and/or block diagram illustrations, and combinations of messages/blocks in the message flow, flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the message flow, flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow, flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

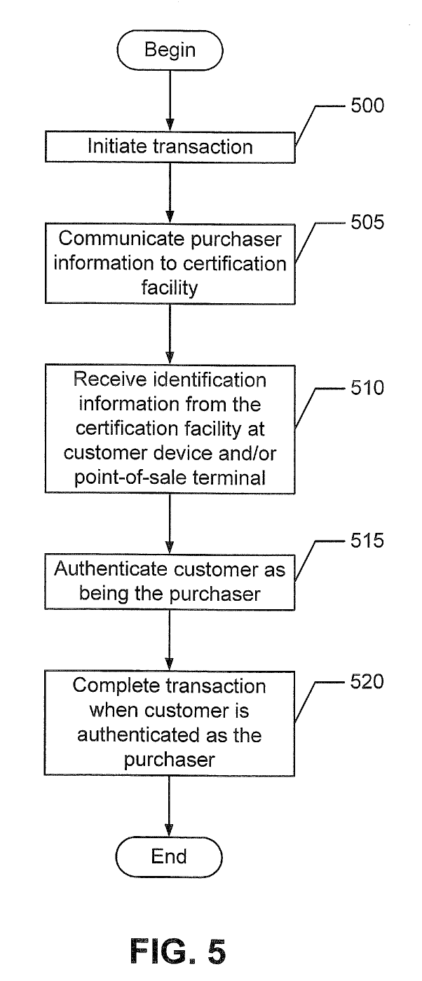

Operations for performing a transaction in which a certification facility provides identification information to an electronic device and/or point-of-sale terminal to authenticate a customer, in accordance with some embodiments of the present invention, will now be described with reference to FIG. 5 and the network and device/system architectures of FIGS. 1-4. Operations begin at block 500 where the electronic device 105 (e.g., mobile terminal 200) initiates a transaction with a point-of-sale terminal 110. At block 505, at the electronic device 105, a user/customer may select his/her self as purchaser and the electronic device 105 may communicate the purchaser information to the certification facility system 115. To provide additional security, the transaction module 285 (see FIG. 2) may be configured to define a personal identification code that is associated with each purchaser. The user/customer may be required to input the personal identification code into the electronic device 105 before the purchasing information is sent to the certification facility system 115 or even before the transaction is initiated with the point-of-sale terminal 110. Alternatively, the personal identification code may be communicated along with the purchaser information to the certification facility system 115, which determines whether the user/customer input the correct identification code for the selected purchaser. If an incorrect identification code has been input, then the certification facility system 115 may terminate the transaction.

In accordance with various embodiments of the present invention, the purchaser information may be communicated to the point-of-sale terminal 110 via NFC, for example, for forwarding to the certification facility system 115 or the electronic device 105 may send the purchaser information directly to the certification facility system 115 over the communication network 120. For additional security, the purchaser information may be encrypted.

The certification facility system 115 receives the purchaser information and responds to the electronic device 105 and/or the point-of-sale terminal 110 with identification information associated with the purchaser at block 510. In accordance with various embodiments of the present invention, the identification information may be an image of the purchaser with or without a verification indicium, such as a digital watermark. In other embodiments, the identification information may be a challenge. For example, the certification facility system 115 may send a challenge question to the electronic device 105 and/or to the point-of-sale system terminal 110, which the user/customer is required to answer to authenticate the user/customer as the purchaser.

In some embodiments, the certification facility system 115 may encrypt the identification information before it is sent to the electronic device 105 and/or the point-of-sale terminal 110. For example, to discourage a user/customer from substituting his/her own image for the image sent from the certification facility system 115, the identification information may be encrypted with a key that is known to a seller, but is unknown to the user/customer.

At block 515, the user/customer is authenticated as being the purchaser. Authentication of the user/customer may be performed in a variety of ways in accordance with various embodiments of the present invention. If an image is sent to the electronic device 105 and/or the point-of-sale terminal 110, then a seller may view the image to determine if it matches the user/customer. If there is a match, then the seller via the point-of-sale terminal may communicate a transaction authorization to the electronic device 105. If the identification information is encrypted, then the identification information may be decrypted first before being used to authenticate the user/customer. For example, if the identification information is encrypted with a key that is known to the seller, but unknown to the user/customer, then the seller may provide the key that is used to decrypt the identification information on the electronic device 105. If the identification information is a challenge, then the user/customer may input a response to the challenge on the electronic device 105. If the response is correct, then the transaction module 285 may authenticate the user/customer on the electronic device 105 or may communicate, via NFC, for example, the correct answer to the point-of-sale terminal 110 to authenticate the user/customer.

It will be understood that the above-described authentication scenarios are merely exemplary and that the user/customer may be authenticated on various ones of the electronic device 105, the point-of-sale terminal 110 and/or the certification facility system 115 to authorize a transaction. Moreover, the various authentication techniques, such as using an image with or without a verification indicium, using a challenge, using a personal identification code and/or using encryption may be combined in various ways depending on the level of security desired.

Returning to FIG. 5, at block 520, the electronic device 105 and the point-of-sale terminal 110 complete the transaction using, for example, NFC technology after the user/customer has been authenticated as being the purchaser.

The flowchart of FIG. 5 illustrates the architecture, functionality, and operations of embodiments of the electronic device 105, the point-of-sale terminal 110, and/or the certification facility system 115 software. In this regard, each block represents a module, segment, or portion of code, which comprises one or more executable instructions for implementing the specified logical function(s). It should also be noted that in other implementations, the function(s) noted in the blocks may occur out of the order noted in FIG. 5. For example, two blocks shown in succession may, in fact, be executed substantially concurrently or the blocks may sometimes be executed in the reverse order, depending on the functionality involved.

Many variations and modifications can be made to the embodiments without substantially departing from the principles of the present invention. All such variations and modifications are intended to be included herein within the scope of the present invention, as set forth in the following claims.

That which is claimed:

1. A method of operating an electronic device to perform a transaction, comprising:
providing purchaser information for communication to a certification facility;
receiving identification information associated with the purchaser from the certification facility; and
completing the transaction responsive to authentication of the user of the electronic device as being the purchaser based on the received identification information.

2. The method of claim 1, wherein the identification information comprises an image.

3. The method of claim 2, wherein the image contains a verification indicium.

4. The method of claim 3, wherein the verification indicium is a digital watermark.

5. The method of claim 2, wherein completing the transaction comprises:
presenting the image to a seller; and
receiving a transaction authorization from the seller responsive to a determination by the seller that the image is associated with the user of the electronic device.

6. The method of claim 1, wherein the identification information comprises a challenge.

7. The method of claim 6, wherein completing the transaction comprises:
receiving a response to the challenge from the user of the electronic device; and
authenticating the user of the electronic device as being the purchaser when the response received is correct.

8. The method of claim 1, wherein the identification information is encrypted with a key known to a seller and unknown to the user of the electronic device.

9. The method of claim 8, wherein completing the transaction comprises:
receiving the key from the seller; and
decrypting the identification information using the key from the seller.

10. The method of claim 1, further comprising:
defining a personal identification code associated with the purchaser;
receiving a code that is input by the user of the electronic device; and
wherein providing the purchaser information comprises:
providing the purchaser information for transmission to the certification facility when the code that is input by the user of the electronic device matches the defined personal identification code associated with the purchaser.

11. The method of claim 1, wherein the purchaser information is encrypted.

12. The method of claim 1, wherein providing purchaser information for communication to a certification facility comprises:
transmitting the purchaser information to a point-of-sale terminal for forwarding to the certification facility.

13. The method of claim 12, wherein transmitting the purchaser information to the point-of-sale terminal comprises transmitting the purchaser information to the point-of-sale terminal using near field communication (NFC) technology.

14. The method of claim 1, wherein providing purchaser information for communication to a certification facility comprises:
transmitting the purchaser information to the certification facility.

15. The method of claim 1, wherein completing the transaction comprises completing the transaction with a point-of-sale terminal using near field communication (NFC) technology.

16. The method of claim 1, wherein the electronic device is a mobile terminal.

17. An electronic device configured to carry out the method of claim 1.

18. A computer program product comprising computer-readable program code embodied on a computer-readable medium, the computer readable program code being configured to carry out the method of claim 1.

19. A method of operating a point-of-sale terminal to perform a transaction, comprising:
receiving identification information associated with a purchaser from a certification facility;
authenticating a customer as being the purchaser based on the received identification information; and
completing the transaction responsive to authentication of the customer as being the purchaser.

20. The method of claim 19, wherein the identification information comprises an image.

21. The method of claim 20, wherein the image contains a verification indicium.

22. The method of claim 21, wherein the verification indicium is a digital watermark.

23. The method of claim 19, wherein the identification information comprises a challenge.

24. The method of claim 23, wherein completing the transaction comprises:
presenting the challenge to the customer;
receiving a response to the challenge from the customer; and
wherein authenticating the customer comprises authenticating the customer as being the purchaser when the response received is correct.

25. The method of claim 20, wherein completing the transaction comprises:
presenting the image to a seller; and
receiving a transaction authorization from the seller responsive to a determination by the seller that the image is associated with the customer.

26. The method of claim 19, further comprising:
receiving purchaser information from an electronic device associated with the customer;
forwarding the purchaser information to the certification facility; and
wherein receiving the identification information comprises receiving the identification information associated with the purchaser from the certification facility responsive to forwarding the purchaser information to the certification facility.

27. The method of claim 25, wherein receiving the purchaser information from the electronic device comprises receiving the purchaser information from the electronic device using near field communication (NFC) technology.

28. The method of claim 19, wherein completing the transaction comprises completing the transaction with an electronic device associated with the customer using near field communication (NFC) technology.

29. A point-of-sale terminal configured to carry out the method of claim 19.

30. A computer program product comprising computer-readable program code embodied on a computer-readable medium, the computer readable program code being configured to carry out the method of claim 19.

31. A method of operating a certification facility to facilitate a transaction, comprising:
receiving purchaser information; and
sending identification information associated with the purchaser to an electronic device associated with a customer and/or a point-of-sale terminal associated with a seller.

32. The method of claim 31, wherein the identification information comprises an image.

33. The method of claim 32, wherein the image contains a verification indicium.

34. The method of claim 33, wherein the verification indicium is a digital watermark.

35. The method of claim 31, wherein the identification information comprises a challenge.

36. The method of claim 31, wherein the identification information is encrypted with a key known to the seller and unknown to the customer.

37. The method of claim 31, wherein the purchaser information is encrypted.

38. A certification facility system configured to carry out the method of claim 31.

39. A computer program product comprising computer-readable program code embodied on a computer-readable medium, the computer readable program code being configured to carry out the method of claim 31.
